(19) United States
(12) Patent Application Publication
(10) Pub. No.: US 2025/0083735 A1
(43) Pub. Date: Mar. 13, 2025

(54) STEERING GEARBOX FOR ROBOTICS CORNER MODULE

(71) Applicant: Schaeffler Technologies AG & Co. KG, Herzogenaurach (DE)

(72) Inventor: Nicholas Hrusch, Wooster, OH (US)

(73) Assignee: Schaeffler Technologies AG & Co. KG, Herzogenaurach (DE)

(21) Appl. No.: 18/402,791

(22) Filed: Jan. 3, 2024

Related U.S. Application Data
(60) Provisional application No. 63/537,490, filed on Sep. 9, 2023.

(51) Int. Cl. B62D 5/04; B25J 9/10; F16H 1/20; F16H 57/021; F16H 57/029

(52) U.S. Cl. CPC B62D 5/0424; B25J 9/102; F16H 1/20; F16H 57/021; F16H 57/029; F16H 2057/02034; F16H 2057/02082

(57) ABSTRACT

A steering gearbox for a robotics corner module includes a lower housing assembly, a center housing assembly, an electric motor, an output shaft assembly, a gear train and a first fastener. The lower housing assembly includes a lower housing and a shaft portion. The center housing assembly includes a center housing. The electric motor includes a stator assembly fixed in the lower housing and a rotor assembly with a rotor shaft. The output shaft assembly includes an output gear. The gear train includes a first shaft assembly with a first gear, and a compound gear assembly rotatably supported on the shaft portion. The compound gear assembly includes a first gear portion meshingly engaged with the output gear and a second gear portion meshingly engaged with the first gear. The first fastener extends through the center housing and into the shaft portion to secure the center housing to the lower housing.

### CROSS-REFERENCE TO RELATED APPLICATIONS

This application claims the benefit of U.S. Provisional Patent Application No. 63/537,490, filed Sep. 9, 2023, the disclosure of which is incorporated in its entirety by reference herein.

### TECHNICAL FIELD

The present disclosure relates generally to a robotics corner module, and more specifically to a steering gearbox for a robotics corner module.

### BACKGROUND

Steerable robots are known. One example is shown and described in United States Patent Application Publication No. 2022/0305672 titled INTEGRATED MOBILE MANIPULATOR ROBOT WITH ACCESSORY INTERFACES to Meduna et al., hereby incorporated by reference as if set forth fully herein.

### SUMMARY

Example embodiments broadly comprise a steering gearbox for a robotics corner module including a lower housing assembly, a center housing assembly, an electric motor, an output shaft assembly, a gear train and a first fastener. The lower housing assembly includes a lower housing and a shaft portion. The lower housing includes a first through bore, a second through bore and a first counterbore. The center housing assembly includes a center housing. The center housing includes a third through bore, a fourth through bore and a fifth through bore. The electric motor includes a stator assembly fixed in the first through bore and a rotor assembly with a rotor shaft extending through the third through bore. The output shaft assembly extends parallel to the rotor shaft and is rotatably supported in the second through bore. The output shaft assembly includes an output gear. The gear train is arranged for driving connection between the rotor shaft and the output shaft assembly. The gear train includes a first shaft assembly with a first shaft and a first gear, and a compound gear assembly. The first shaft extends parallel to the rotor shaft, is at least partially disposed in the first counterbore and extends through the fourth through bore. The compound gear assembly is rotatably supported on the shaft portion. The compound gear assembly includes a first gear portion meshingly engaged with the output gear and a second gear portion meshingly engaged with the first gear. The first fastener extends through the fifth through bore and into the shaft portion to secure the center housing to the lower housing.

In an example embodiment, the output shaft assembly is rotatably supported in the second through bore by a bushing. In some example embodiments, the first shaft is rotatably supported in the first counterbore by a first needle bearing, and rotatably supported in the fourth through bore by a first ball bearing. In some example embodiments, the steering gearbox also includes a bearing housing secured to the lower housing. The bearing housing includes a sixth through bore and the first shaft is rotatably supported by a second needle bearing disposed in the sixth through bore. In an example embodiment, the bearing housing is secured to the lower housing by fasteners and the center housing includes access holes for tightening the fasteners.

In an example embodiment, the compound gear assembly is rotatably supported on the shaft portion by a second ball bearing and a third needle bearing. In an example embodiment, the output gear, the first gear, and the compound gear assembly are disposed axially between the lower housing and the center housing. In some example embodiments, the center housing includes a cylindrical protrusion at least partially disposed in the first through bore. In an example embodiment, the center housing assembly includes an o-ring sealingly engaged between the cylindrical protrusion and the first through bore.

In some example embodiments, the first shaft assembly also includes a second gear secured to the first shaft by a second fastener. In some example embodiments, the steering gearbox also includes an upper housing assembly with an upper housing secured to the lower housing, and the second gear is disposed axially between the center housing and the upper housing. In some example embodiments, the center housing assembly also includes a second shaft fixed in the center housing, and the gear train also includes an idler gear assembly with an idler gear rotatably supported on the second shaft and meshingly engaged with the second gear. In an example embodiment, the rotor assembly includes a pinion gear fixed to the rotor shaft and meshingly engaged with the idler gear.

In some example embodiments, the steering gearbox also includes an upper housing assembly secured to the lower housing assembly and a bearing nut. The upper housing assembly includes an upper housing with a seventh through bore and a ball bearing secured in the seventh through bore. The bearing nut is threaded onto the output shaft to secure the ball bearing to the output shaft. In an example embodiment, the upper housing assembly also includes a seal arranged to seal the bearing nut to the seventh through bore. In an example embodiment, the steering gearbox also includes an encoder target fastened to the bearing nut for detecting rotation or angular position of the output shaft assembly.

In some example embodiments, the output shaft assembly also includes an internal spline portion arranged for driving engagement with a lower shaft. In an example embodiment, the output shaft assembly also includes a ring groove arranged for receiving a ring to axially secure the lower shaft to the output shaft assembly.

### BRIEF DESCRIPTION OF THE DRAWINGS

FIG. 1 illustrates a perspective view of a robotics corner module.

FIG. 2 illustrates a perspective view of a steering gearbox of FIG. 1.

FIG. 3 illustrates a cross-sectional view of the steering gearbox of FIG. 2.

FIG. 4a illustrates an exploded view of a lower housing assembly of the steering gearbox of FIG. 2.

FIG. 4b illustrates an assembled view of the lower housing assembly of FIG. 4a.

FIG. 5a illustrates an exploded view of a center housing assembly of the steering gearbox of FIG. 2.

FIG. 5b illustrates an assembled view of the center housing assembly of FIG. 5a.

FIG. 6a illustrates an exploded view of output shaft assembly of the steering gearbox of FIG. 2.

FIG. 6b illustrates an assembled view of the output shaft assembly of FIG. 6a.

FIG. 7a illustrates an exploded view of shaft assembly of the steering gearbox of FIG. 2.

FIG. 7b illustrates an assembled view of the shaft assembly of FIG. 7a.

FIG. 8a illustrates an exploded view of compound gear assembly of the steering gearbox of FIG. 2.

FIG. 8b illustrates an assembled view of the compound gear assembly of FIG. 8a.

FIG. 9a illustrates an exploded view of a bearing housing assembly of the steering gearbox assembly of FIG. 2.

FIG. 9b illustrates a perspective view of the bearing housing assembly of FIG. 9a.

FIG. 10a illustrates an exploded view of a rotor assembly 138 of the steering gearbox of FIG. 2.

FIG. 10b illustrates a perspective view of the rotor assembly of FIG. 10a.

FIG. 11a illustrates an exploded view of an idler gear assembly of the steering gearbox of FIG. 2.

FIG. 11b illustrates a perspective view of the idler gear assembly of FIG. 11a.

FIG. 12 illustrates a perspective view of the steering gearbox of FIG. 2 shown partially assembled.

FIG. 13 illustrates a perspective view of the partially assembled steering gearbox of FIG. 12 shown assembled with a center housing.

FIG. 14 illustrates a perspective view of the partially assembled steering gearbox of FIG. 13 shown assembled with a second gear.

FIG. 15 illustrates a perspective view of an upper housing assembly of the steering gearbox of FIG. 2.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

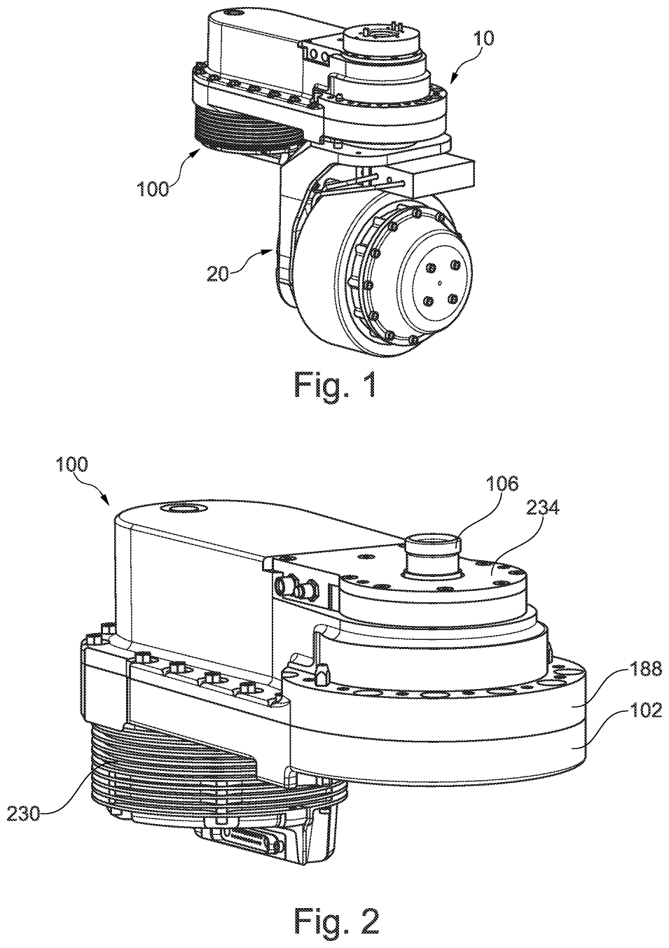

The following description is made with reference to FIG. 1. FIG. 1 illustrates a perspective view of robotics corner module 10. Robotics corner module 10 includes traction drive 20 and steering gearbox 100. A robot (not shown) may include multiple (e.g., four) corner modules fixed to a main chassis for maneuvering the robot, for example. That is, traction drive 20 propels the robot and steering gearbox 100 adjusts the traction drive to steer the robot in a particular direction. The corner module may be controlled by a robot computer (not shown) for autonomous operation of the robot, for example. It should be noted that steering gearbox 100 may be configured as a “left hand” (front left and rear right corner) and a “right hand” (front right and rear left corner) assembly, depending on its location on the robot.

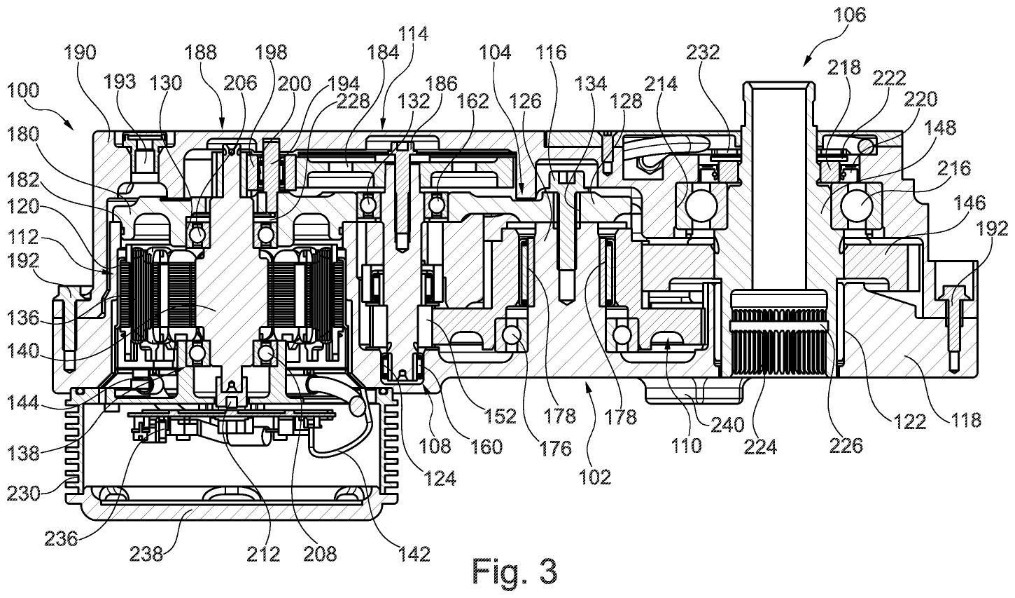

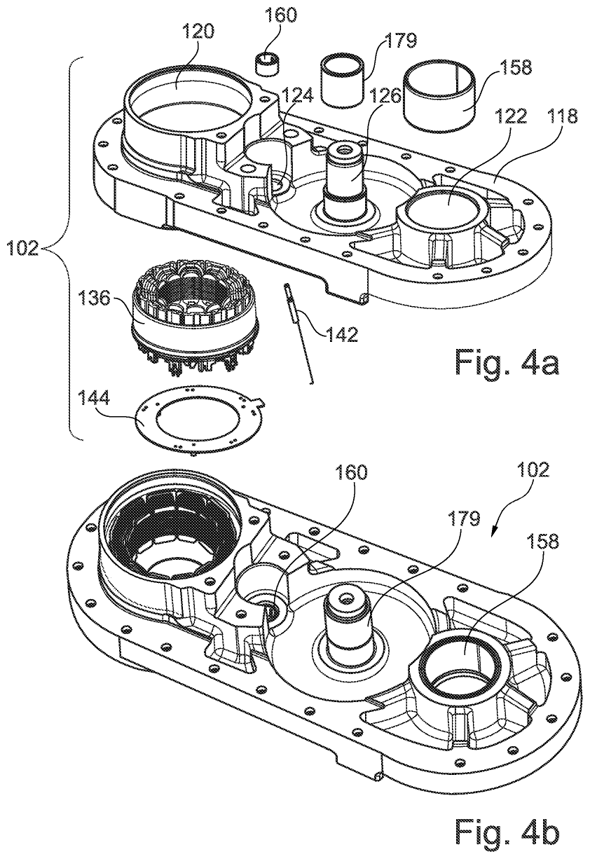

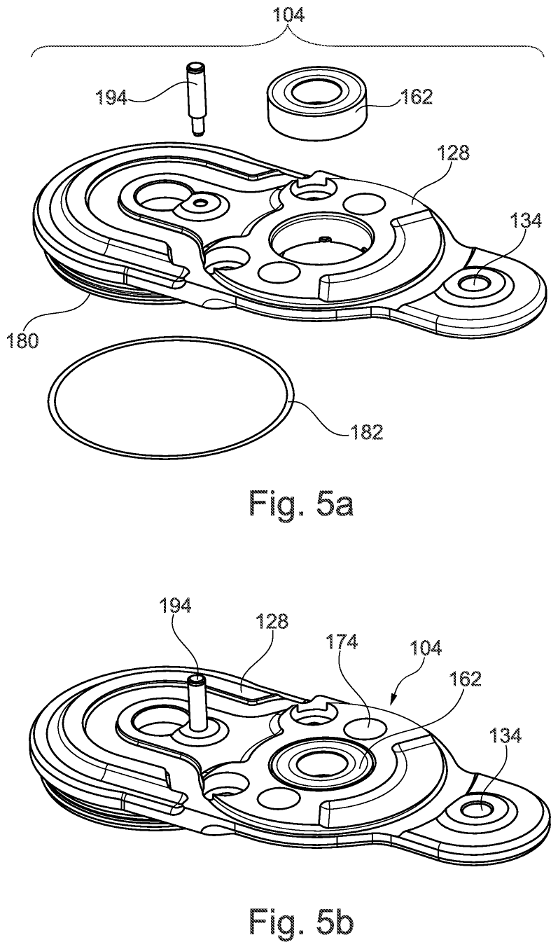

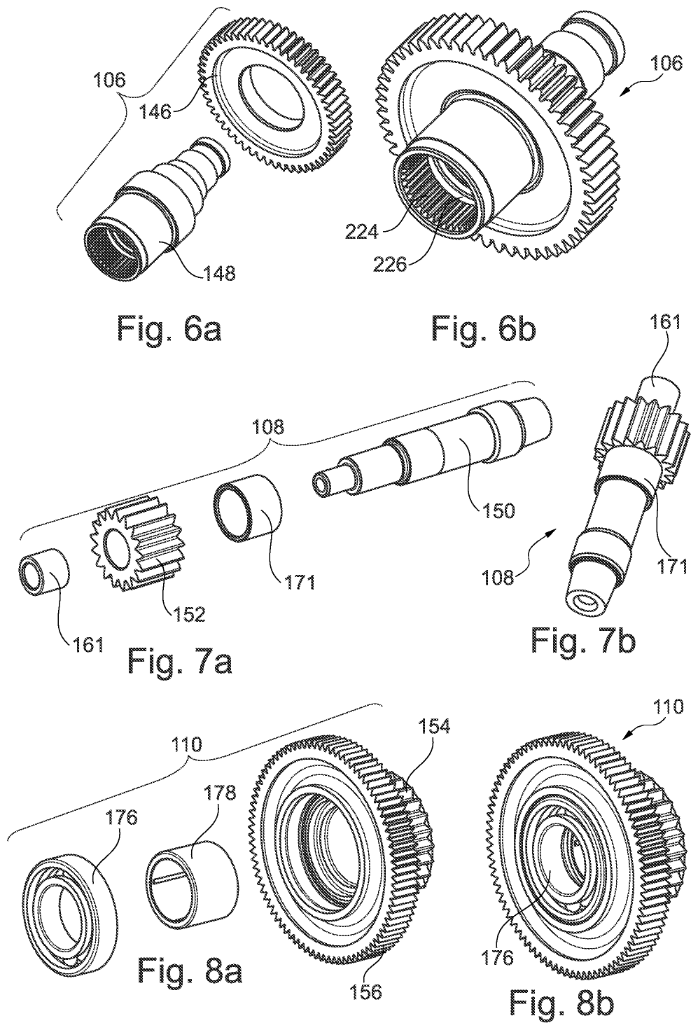

The following description is made with reference to FIGS. 1-8b. FIG. 2 illustrates a perspective view of steering gearbox 100 of FIG. 1. FIG. 3 illustrates a cross-sectional view of the steering gearbox of FIG. 2. FIG. 4a illustrates an exploded view of lower housing assembly 102. FIG. 4b illustrates an assembled view of the lower housing assembly of FIG. 4a. FIG. 5a illustrates an exploded view of center housing assembly 104. FIG. 5b illustrates an assembled view of the center housing assembly of FIG. 5a. FIG. 6a illustrates an exploded view of output shaft assembly 106. FIG. 6b illustrates an assembled view of the output shaft assembly of FIG. 6a. FIG. 7a illustrates an exploded view of shaft assembly 108. FIG. 7b illustrates an assembled view of the shaft assembly of FIG. 7a. FIG. 8a illustrates an exploded view of compound gear assembly 110. FIG. 8b illustrates an assembled view of the compound gear assembly of FIG. 8a.

Steering gearbox 100 for robotics corner module 10 includes lower housing assembly 102, center housing assembly 104, electric motor 112, output shaft assembly 106, gear train 114 and fastener 116. Lower housing assembly 102 includes lower housing 118 with through bores 120 and 122, and counterbore 124. Lower housing assembly 102 also includes shaft portion 126. Shaft portion 126 may be integrally formed with the lower housing from a same piece of material or a separate component attached to the lower housing, for example. Center housing assembly 104 includes center housing 128 with through bores 130, 132 and 134. Electric motor 112 includes stator assembly 136 fixed in through bore 120 and rotor assembly 138 with rotor shaft 140 extending through through bore 130. Bore 120 may be a tapered bore and stator assembly 136 may be press-fit into the bore, for example. As can be seen in FIG. 4a, for example, the electric motor may include thermocouple 142 affixed (e.g., with epoxy) to the stator assembly for determining a temperature of the stator assembly, for example. Busbar board 144 may be electrically connected to the stator assembly for providing a multi-phase power to the stator, for example.

As shown in FIGS. 3, 6a and 6b, for example, output shaft assembly 106 extends parallel to the rotor shaft and is rotatably supported in through bore 122. Output shaft assembly 106 includes output gear 146. Output gear 146 may be integrally formed with shaft portion 148 of the output shaft assembly or, as shown in FIGS. 6a and 6b, for example, a separate component fixed to the shaft portion by press-fitting, shrink fitting, adhesives, staking or welding, for example.

The following description is made with reference to FIGS. 3, and 7a-8b. Gear train 114 is arranged for driving connection between the rotor shaft and the output shaft assembly as described in more detail below. Gear train 114 includes shaft assembly 108 and compound gear assembly 110. Shaft assembly 108 includes shaft 150 extending parallel to the rotor shaft, and gear 152. Gear 152 may be integrally formed with shaft 150 or a separate component affixed to shaft 150 similar to output gear 146 discussed above. Shaft 150 is partially disposed in counterbore 124 and extends through through bore 132. Compound gear assembly 110 is rotatably supported on shaft portion 126 and includes gear portion 154 meshingly engaged with the output gear and gear portion 156 meshingly engaged with gear 152. Gear portions 154 and 156 may be integrally formed from a single piece of material or be separate gears joined together. Fastener 116 extends through through bore 134 and into the shaft portion to secure the center housing to the lower housing.

The following description is made with reference to FIGS. 3, 4a-5b and 7a-7b. Output shaft assembly 106 is rotatably supported in through bore 122 by bushing 158. For example, as shown in FIGS. 4a and 4b, bushing 158 may be press-fit into bore 122 prior to installation of the output shaft assembly into the lower housing assembly, allowing free rotation of shaft portion 148 in the lower housing with reduced friction. Shaft 150 is rotatably supported in counterbore 124 by needle bearing 160 and rotatably supported in through bore 132 by ball bearing 162. For example, as shown in FIGS. 7a and 7b, needle bearing 160 may be press-fit into the lower housing prior to installation of shaft 150, allowing the shaft to rotate freely in the lower housing with reduced friction. Similarly, as shown in FIGS. 5a and 5b, ball bearing 162 may be press-fit into the center housing prior to installation of shaft 150, allowing the shaft to rotate freely in the housing with reduced friction. Center housing 128 may be staked by deforming material of the housing to retain bearing 162.

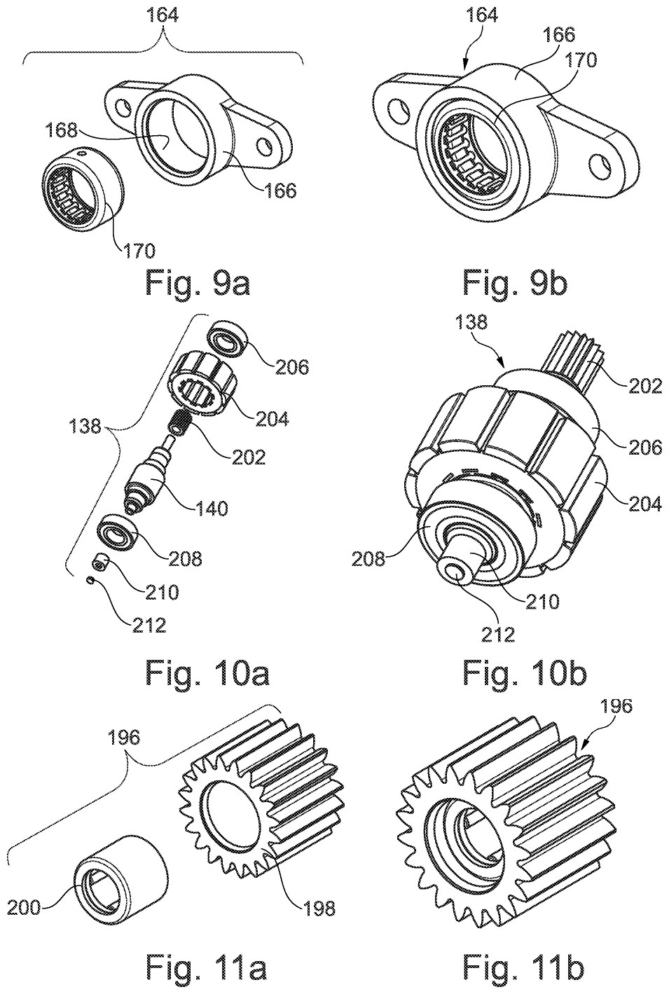

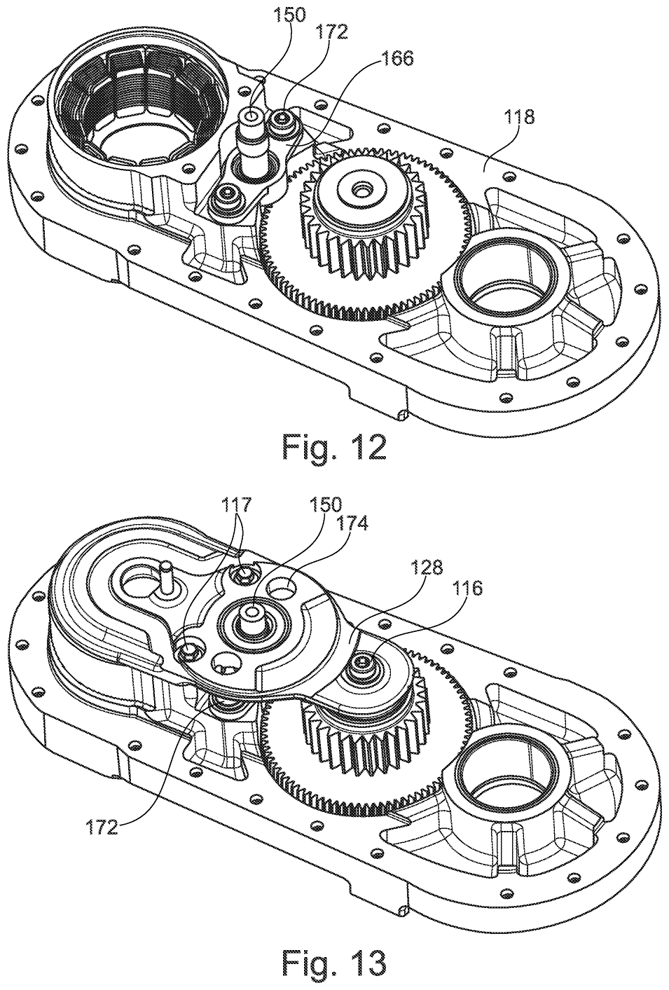

The following description is made with reference to FIGS. 9a-9b and 12. FIG. 9a illustrates an exploded view of bearing housing assembly 164 of steering gearbox assembly 100 of FIG. 2. FIG. 9b illustrates a perspective view of the bearing housing assembly of FIG. 9a. FIG. 12 illustrates a perspective view of steering gearbox 100 shown partially assembled. The steering gearbox also includes bearing housing, or bearing support block, 166 secured to lower housing 118. Bearing housing 166 includes through bore 168. Shaft 150 is rotatably supported by needle bearing 170 disposed in through bore 168. For example, needle bearing 170 may be press-fit into through bore 168, forming bearing housing assembly 164, allowing the shaft to rotate freely in the bearing housing with reduced friction. Bearing housing 166 is secured to lower housing 118 by fasteners 172. Shaft assembly 108 may include hardened races 161 and 171 press-fit onto shaft portion 150 to provide a hardened running surface for bearings 160 and 170, respectively.

The following description is made with reference to FIGS. 12-13. FIG. 13 illustrates a perspective view of the partially assembled steering gearbox 100 of FIG. 12 shown assembled with center housing 128. Center housing 128 includes access holes 174 for tightening fasteners 172. Holes 174 permit installation of center housing 128 on lower housing 118 prior to tightening fasteners 172. Clearance between the fasteners and the bearing housing permits the shaft to find a center between bearings 160 in the lower housing and 162 in the center housing without binding from bearing 170. In other words, the bearing housing can float to align with the shaft (instead of the shaft aligning to the bearing housing) until the center housing is secured and fasteners 172 are tightened to fully secure the bearing housing assembly to the lower housing. Access holes 174 permit a tool for tightening fasteners 172 to extend through the center housing to access the fasteners.

The following description is made with reference to FIGS. 3 and 8a-8b. FIG. 8a illustrates an exploded view of compound gear assembly 110 of steering gearbox 100. FIG. 8b illustrates a perspective view of the compound gear assembly of FIG. 8a. Compound gear assembly 110 is rotatably supported on shaft portion 126 by ball bearing 176 and needle bearing 178. Lower housing assembly 102 may include hardened sleeve 179 press-fit on shaft portion 126 and arranged to provide a hardened surface for needle bearing 178 to rotate on. As best shown in FIG. 3, output gear 146, gear 152, and compound gear assembly 110 are disposed axially between the lower housing and the center housing. In other embodiments (not shown), bearings 176 and 178 may be replaced with a single bushing, eliminating inner race 179 and shaft feature 126 may include a single bushing support diameter.

The following description is made with reference to FIGS. 3 and 5a-5b. Center housing 128 includes cylindrical protrusion 180 disposed in through bore 120. Center housing assembly 104 includes o-ring 182 sealingly engaged between the cylindrical protrusion and the through bore. That is, the cylindrical protrusion includes a groove and the o-ring may be installed in the groove prior to assembling the center housing assembly to the lower housing. The o-ring provides sealing to prevent grease, dust or other debris from entering the portion of through bore 120 where stator assembly 136 is located, helping prolong a service life of electric motor 112.

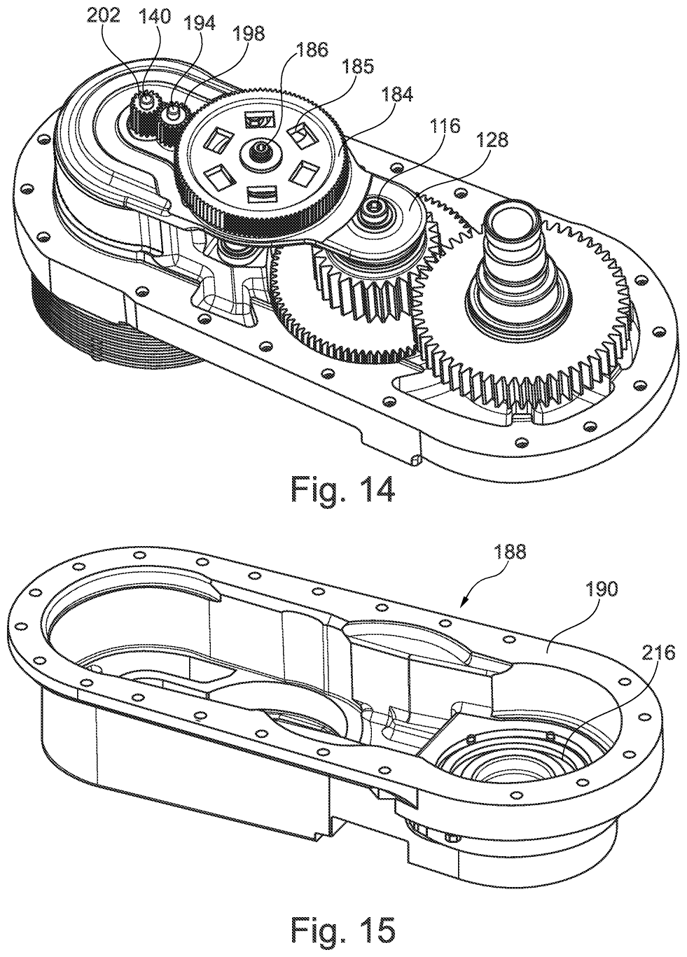

The following description is made with reference to FIGS. 3 and 14. FIG. 14 illustrates a perspective view of partially assembled steering gearbox 110 of FIG. 13 shown assembled with gear 184. Shaft assembly 108 also includes gear 184 secured to shaft 150 by fastener 186. Shaft 150 may have a tapered portion and gear 184 may include a tapered bore so that tightening fastener 186 wedges the two tapered areas together and gear 184 is securely fastened to shaft 150 for cojoint rotation. In other words, the gear is affixed to the shaft so that rotation of gear 184 also rotates shaft 150, and vice versa. Gear 184 is secured in this manner to allow assembly of center housing 128 and support bearing 162 prior to installation of the gear.

The following description is made with reference to FIGS. 2-3 and FIG. 15. FIG. 15 illustrates a perspective view of upper housing assembly 188 of steering gearbox 100 of FIG. 2. Steering gearbox 100 also includes upper housing assembly 188 with upper housing 190 secured to the lower housing (e.g., via fasteners 192). As shown in FIG. 3, for example gear 184 is disposed axially between the center housing and the upper housing. Housing vent 193 may be threaded into the upper housing.

The following description is made with reference to FIGS. 3, 5a-5b, 11a-11b and 14. FIG. 11a illustrates an exploded view of an idler gear assembly of the steering gearbox of FIG. 2. FIG. 11b illustrates a perspective view of the idler gear assembly of FIG. 11a. Center housing assembly 104 also includes shaft 194 fixed in center housing 128. Gear train 114 includes idler gear assembly 196 with idler gear 198 rotatably supported on shaft 194 and meshingly engaged with gear 184. For example, idler gear assembly 196 may include needle bearing 200 press-fit into idler gear 198 allowing free rotation of the idler gear on the shaft with minimal friction.

The following description is made with reference to FIGS. 3, 10a-10b and 14. FIG. 10a illustrates an exploded view of rotor assembly 138 of steering gearbox 100 of FIG. 2. FIG. 10b illustrates a perspective view of the rotor assembly of FIG. 10a. Rotor assembly 138 includes pinion gear 202 fixed to rotor shaft 140 and meshingly engaged with idler gear 198. Rotor assembly 138 also includes rotor laminations with bonded permanent magnets 204, bearings 206 and 208, magnet housing 210 and magnet 212 secured to rotor shaft 140. Magnet 212 may be glued in magnet housing 210, for example. The bearings allow low friction rotation of the rotor assembly and the magnet provides rotation information of the rotor shaft to driver board 236 for proper synchronization of the multi-phase power supplied to the stator assembly.

Returning to FIG. 3, upper housing assembly 188 is secured to lower housing assembly 102 via fasteners 192, for example. The upper housing assembly includes upper housing 190 with through bore 214 and ball bearing 216 secured in bore 214. Bearing 216 may be a four point contact bearing press-fit in the bore, for example. Steering gearbox 100 also includes bearing nut 218 threaded onto shaft portion 148 to secure the ball bearing to the output shaft assembly. Bore 214 and shaft portion 148 include respective stepped diameters and bearing 216 is arranged axially between the stepped diameters. Upper housing assembly 188 also includes seal 220 arranged to seal the bearing nut to through bore 214. Steering gearbox 100 also includes encoder target 222 fastened to the bearing nut for detecting rotation or angular position of the output shaft assembly. Output shaft assembly 106 also includes internal spline portion 224 arranged for driving engagement with a lower shaft (not shown) and ring groove 226 arranged for receiving a ring (not shown) to axially secure the lower shaft to the output shaft assembly.

The following description of an assembly method of the steering gearbox is made with reference to FIGS. 1-15. Starting with lower housing assembly 102, a washer may be placed under shaft assembly 108 before assembly into needle roller bearing 160. Compound gear assembly 110 is placed on shaft portion 126 and washers placed on the shaft portion and shaft 150. Bearing housing assembly 164 is slipped over shaft 150 and fasteners 172 started but NOT yet tightened. Center support assembly 104 is installed simultaneously into bore 120 of the lower housing and shaft assembly 108 before being fastened into place with fasteners 116 and 117. Fasteners 172 are then tightened, through clearance holes 174 in the center housing 128.

The partially assembled gearbox is flipped over and wave spring 228 is inserted into center housing bore 130. Using special tooling to prevent the rotor assembly from touching the stator assembly, the rotor assembly is installed thru the stator assembly, and phase wires are fastened to the busbar board 144. The rotor shaft may be supported by driver board housing 230, sealed and fastened to the lower housing. At this point, the assembly is flipped again. Gear 184 is installed onto the end of shaft 150 using a washer and fastener 186 to draw the gear down onto the shaft. Bearing puller windows 185 on gear 184 allow disassembly and to react tightening torque from the fastener. Idler gear assembly 196 is installed on pin 194 with a washer on either side. Output shaft assembly 106 is then installed into the lower housing and grease is applied over all meshes between the gears.

After all gears are in place and greased, the upper housing assembly can be installed while aligning both bearing 216 to the output shaft and upper housing 190 to pin 194. The upper housing assembly is then fastened to the lower housing assembly with fasteners 192. Bearing preload nut 218 is tightened to preload bearing 216. Encoder target 218 is fastened to the preload nut. A pair of encoder sensor boards are fastened to the upper housing, which provide redundant measurement of the output shaft position versus rotor shaft position. That is, because there are two independent boards, position of the output shaft is determined even if one of the boards fails. Encoder cap 234 is fastened to the upper housing with connectors and wire attached to the encoder sensor boards to allow the sensor output to be read externally. Plugs are installed into any unused ports in the encoder cap. This allows the same parts to be used for left and right hand versions.

After flipping the assembly once again, thermal pads are bonded to driver board housing 230, and driver board 236 is fastened while connecting the phase wires with additional fasteners and the thermocouple leads to the board. Driver board housing lid 238 is fastened to the driver board housing, including a connector with fasteners which allows communication to the driver board.

During operation, torque is produced between the motor stator and rotor, which drives the parallel axis gearing arrangement. Torque flows through the pinion gear, idler gear, gear 184 though shaft 150 to gear 152, compound gear assembly 110 to output gear 146 before outputting on the output shaft spline to the traction drive assembly. Along the way, a total gear ratio of around 64:1 is achieved with the depicted components, and a pair of dead stops 220 degrees apart on the lower housing assembly restrict the total travel to +/−110 degrees.

Center support assembly 104 improves bearing arrangements and sensitivity to tolerances by tightening stackup loops between the two ends of rotor shaft 140, gear shaft 15, idler gear assembly 196, and shaft portion 126. As a result, the upper housing only needs to align with two axes to assemble (output shaft and pin). Thus 5 gear axes do not need to be simultaneously aligned to go together. Likewise the assembly method described around the bearing support block allows for a 3rd floating support point on gear shaft 150, which reduces stress on the shafts and gear meshes.

Other embodiments may include bearings replaced with bushings and hardened races eliminated or integrated with shafts. Seals may be eliminated or replaced with simple o-rings and connectors may be different.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

10 Robotics corner module
20 Traction drive
100 Steering gearbox
102 Lower housing assembly
104 Center housing assembly
106 Output shaft assembly
108 Shaft assembly (first)
110 Compound gear assembly
112 Electric motor
114 Gear train
116 Fastener (first, center housing to shaft portion)
117 Fastener (center housing to lower housing)
118 Lower housing
120 Through bore (first, lower housing)
122 Through bore (second, lower housing)
124 Counterbore (first, lower housing)
126 Shaft portion (lower housing)
128 Center housing
130 Through bore (third, center housing)
132 Through bore (fourth, center housing)
134 Through bore (fifth, center housing)
136 Stator assembly (electric motor)
138 Rotor assembly (electric motor)
140 Rotor shaft
142 Thermocouple
144 Busbar board
146 Output gear
148 Shaft portion (output shaft assembly)
150 Shaft (first)
152 Gear (first)
154 Gear portion (first, compound gear assembly)
156 Gear portion (second, compound gear assembly)
158 Bushing
160 Needle bearing (first)
161 Hardened race (shaft assembly)
162 Ball bearing (first)
164 Bearing housing assembly
166 Bearing housing
168 Through bore (sixth, bearing housing)
170 Needle bearing (bearing housing)
171 Hardened race (shaft assembly)
172 Fasteners (bearing housing to lower housing)
174 Access holes (center housing)
176 Ball bearing (second, compound gear assembly)
178 Needle bearing (third, compound gear assembly)
180 Cylindrical protrusion (center housing)
182 O-ring (center housing assembly)
184 Gear (second)
185 Bearing puller windows (second gear)
186 Fastener (second, second gear to first shaft)
188 Upper housing assembly
190 Upper housing
192 Fasteners (upper housing to lower housing)
193 Housing vent
194 Shaft (second, center housing)
196 Idler gear assembly
198 Idler gear
200 Needle bearing (idler gear)
202 Pinion gear (rotor shaft)
204 Rotor laminations with bonded permanent magnets
206 Bearing (rotor assembly)
208 Bearing (rotor assembly)
210 Magnet housing (rotor assembly)
212 Magnet (rotor assembly)
214 Through bore (seventh, upper housing)
216 Ball bearing (upper housing)
218 Bearing nut
220 Seal (upper housing assembly)
222 Encoder target
224 Internal spline portion (output shaft assembly)
226 Ring groove (output shaft assembly)
228 Wave spring
230 Driver board housing
232 Encoder sensor board
234 Encoder cap
236 Driver board
238 Driver board cap
240 Dead stops

What is claimed is:

1. A steering gearbox for a robotics corner module, comprising:
a lower housing assembly comprising:
a lower housing comprising:
a first through bore;
a second through bore; and
a first counterbore; and
a shaft portion;
a center housing assembly comprising a center housing, the center housing comprising:
a third through bore;
a fourth through bore; and
a fifth through bore;
an electric motor comprising:
a stator assembly fixed in the first through bore; and
a rotor assembly comprising a rotor shaft extending through the third through bore;
an output shaft assembly extending parallel to the rotor shaft and rotatably supported in the second through bore, the output shaft assembly comprising an output gear;
a gear train arranged for driving connection between the rotor shaft and the output shaft assembly, the gear train comprising:
a first shaft assembly comprising:
a first shaft:
extending parallel to the rotor shaft;
at least partially disposed in the first counterbore; and
extending through the fourth through bore; and
a first gear; and
a compound gear assembly rotatably supported on the shaft portion, the compound gear assembly comprising:
a first gear portion meshingly engaged with the output gear; and
a second gear portion meshingly engaged with the first gear; and
a first fastener extending through the fifth through bore and into the shaft portion to secure the center housing to the lower housing.

2. The steering gearbox of claim 1 wherein the output shaft assembly is rotatably supported in the second through bore by a bushing.

3. The steering gearbox of claim 1 wherein the first shaft is:
rotatably supported in the first counterbore by a first needle bearing; and
rotatably supported in the fourth through bore by a first ball bearing.

4. The steering gearbox of claim 3 further comprising a bearing housing secured to the lower housing and comprising a sixth through bore, wherein the first shaft is rotatably supported by a second needle bearing disposed in the sixth through bore.

5. The steering gearbox of claim 4 wherein:
the bearing housing is secured to the lower housing by fasteners; and
the center housing comprises access holes for tightening the fasteners.

6. The steering gearbox of claim 1 wherein the compound gear assembly is rotatably supported on the shaft portion by a second ball bearing and a third needle bearing.

7. The steering gearbox of claim 1 wherein the output gear, the first gear, and the compound gear assembly are disposed axially between the lower housing and the center housing.

8. The steering gearbox of claim 1 wherein the center housing comprises a cylindrical protrusion at least partially disposed in the first through bore.

9. The steering gearbox of claim 8 wherein the center housing assembly comprises an o-ring sealingly engaged between the cylindrical protrusion and the first through bore.

10. The steering gearbox of claim 1 wherein the first shaft assembly further comprises a second gear secured to the first shaft by a second fastener.

11. The steering gearbox of claim 10 further comprising an upper housing assembly comprising an upper housing secured to the lower housing, wherein the second gear is disposed axially between the center housing and the upper housing.

12. The steering gearbox of claim 11 wherein the center housing assembly further comprises a second shaft fixed in the center housing, wherein the gear train further comprises an idler gear assembly with an idler gear rotatably supported on the second shaft and meshingly engaged with the second gear.

13. The steering gearbox of claim 12 wherein the rotor assembly comprises a pinion gear fixed to the rotor shaft and meshingly engaged with the idler gear.

14. The steering gearbox of claim 1 further comprising:
an upper housing assembly secured to the lower housing assembly, the upper housing assembly comprising:
an upper housing with a seventh through bore; and
a ball bearing secured in the seventh through bore; and
a bearing nut threaded onto the output shaft to secure the ball bearing to the output shaft.

15. The steering gearbox of claim 14 wherein the upper housing assembly further comprises a seal arranged to seal the bearing nut to the seventh through bore.

16. The steering gearbox of claim 14 further comprising an encoder target fastened to the bearing nut for detecting rotation or angular position of the output shaft assembly.

17. The steering gearbox of claim 1 wherein the output shaft assembly further comprises an internal spline portion arranged for driving engagement with a lower shaft.

18. The steering gearbox of claim 17 wherein the output shaft assembly further comprises a ring groove arranged for receiving a ring to axially secure the lower shaft to the output shaft assembly.
